(19) United States
(12) Patent Application Publication
(10) Pub. No.: US 2014/0358718 A1
(43) Pub. Date: Dec. 4, 2014

(54) Customizable Plate

(71) Applicant: Sandy Casey, Livermore, CA (US)

(72) Inventor: Sandy Casey, Livermore, CA (US)

(21) Appl. No.: 14/293,922

(22) Filed: Jun. 2, 2014

Related U.S. Application Data
(60) Provisional application No. 61/829,924, filed on May 31, 2013.

(51) Int. Cl. A47G 19/02; G06Q 30/06

(52) U.S. Cl. CPC A47G 19/02; G06Q 30/0621; G06Q 30/0635
USPC 705/26.5; 220/574

(57) ABSTRACT

A customizable plate system comprising a plate having a central clear portion and a decal configured to selectively couple with the underside of the plate at the central clear portion, such that a design on the decal shows through the central clear portion of the plate. The decal can be removable, so that it can be replaced with a different decal. The decals can be selected such that the design of the decal applied to the plate can match the surrounding decor and/or occasion.

### CROSS REFERENCE TO RELATED APPLICATIONS

This Application claims priority under 35 U.S.C. §119(e) from earlier filed U.S. Provisional Application Ser. No. 61/829,924, filed May 31, 2013, the entirety of which is incorporated herein by reference.

### BACKGROUND

1. Field of the Invention

The present disclosure relates to customizable dishware, particularly customizable plates having transparent spaces for removable and/or re-usable decals and designs.

2. Background

It is a common practice for consumers to decorate their tables for holidays, birthdays, weddings, dinner parties, or other events. Often, people look to match the colors and themes of a season or the decor of a room, or decorate for special occasions or “just because.” Part of decorating a table can involve selecting tableware, such as plates.

Generally, consumers cannot have all of the plates they want due to a lack of cabinet space, limited discretionary income, or limited design options. For example, if someone wanted to have table decor for Halloween, Thanksgiving, Christmas and Easter in addition to standard everyday tableware, they would spend a great deal on each set and would struggle to keep them stored due to limited living space storage. Even if the consumer did have extensive cabinet space, unlimited funding, and all of the designs they would desire, they would likely still find it difficult to rationalize the purchase due to the infrequency of use.

Additionally party planners, as a whole, have very limited table design options for the events they organize, due to their limited storage space. With the recent popularity of personalization, the party planners cannot meet the needs of their customers in a cost-effective manner. For design purposes, including a variety of colors and themes, it can be problematic for party planners to maintain and store plates of many different looks. In addition to limited colors and themes, they also cannot have a personalized table setting on hand and stored for every event, such as plates with a photo of every bride and groom they assist in planning Along with storage space the cost per personalized plates are very high. Personalized settings could end up costing the consumer thousands versus hundreds in many instances. All in all, this would be too expensive for most consumers.

Paper plates with personalized designs that may be appropriate for a specific event can be available. However, the design options are limited and often have to be purchased in bulk. Even if the design fits the event and the personalization could be fulfilled, it could be noted that most people would prefer to use higher-quality plates, especially at special events such weddings, baptisms, and bar/bat mitzvahs. Some may also find disposable plates to be environmentally unfriendly. Paper plates, over-all, get “hot” on the bottom and some people would not want to “cut” into the images/photos on top of the plate. Additionally, there may be some concern over food safety.

It can also be desirable to customize plates with a personal design, photographs and/or customized text. For example, a baby's first birthday would be cause for a family celebration. However, for a birthday party having 30 invited guests, for example, it would be too expensive to purchase a melamine fired plate for everyone attending, and paper plates come with some overriding concerns on food safety due to ink, personal concerns on cutting “into” a photograph and “hot” bottoms which could lend itself to another safety concern.

What is needed is a customizable tableware system comprising plates that have a transparent central section and decals that can be selectively and removably applied to the underside of the transparent central section of the plate, such that a decal's design shows through the transparent central section of the plate.

### BRIEF DESCRIPTION OF THE DRAWINGS

FIG. 1a depicts a top view of an embodiment of the present device having a substantially circular geometry.

FIG. 1b depicts a top view of an embodiment of the present device having a substantially square geometry.

FIG. 1c depicts a side view of the embodiment shown in FIG. 1a.

FIG. 2 depicts a top view of an embodiment of a decal.

FIG. 3 depicts an embodiment of a decal being applied to the underside of a plate.

FIG. 4 depicts an embodiment of a decal being applied to the underside of a plate with the use of an application tool.

FIG. 5 depicts a top view of an embodiment of a substantially circular plate having a decal applied to its underside, such that a decal's design is visible though a plate's central substantially transparent section.

FIG. 6 depicts a plurality of decals that can be selectively applied to the underside of a plate.

FIG. 7 depicts an embodiment of a storage container for decals for the present device.

FIG. 8a depicts another embodiment of the present device for a bowl.

FIG. 8b depicts another embodiment of the present device for a drinking vessel.

FIG. 9 depicts a method of providing plates and/or decals to users.

### DETAILED DESCRIPTION

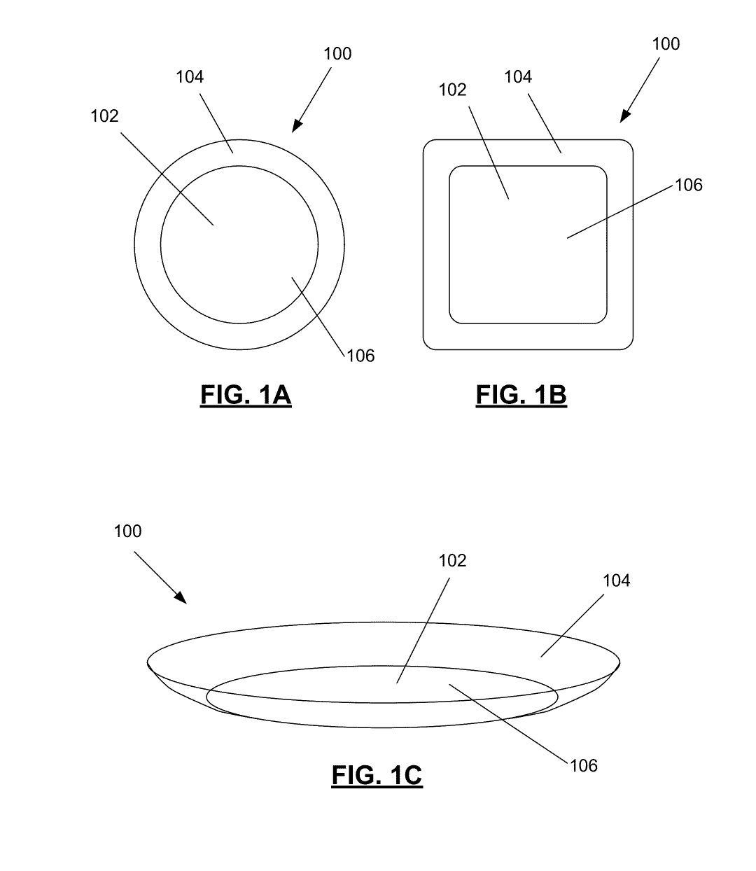

FIG. 1a depicts a top view of one embodiment of a dish in the present device. In some embodiments a dish can be a plate 100, which can have a substantially circular geometry. In other embodiments, a plate 100 can have a substantially rectangular geometry, such as a substantially square, as shown in FIG. 1b. However in other embodiments, a plate 100 can have a substantially elliptoid, octagonal, or any other known and/or convenient geometry. In some embodiments, a plate can be fabricated from a polymer, glass, or any other known and/or convenient material.

In some embodiments, a plate 100 can have a substantially planar central portion 102 surrounded at its edges by a rim 104 or perimeter portion 104. As shown in the side view of FIG. 1c, a rim 104 can have a slight curvature and be raised above the plane of a substantially planar central portion 102, but in other embodiments can be substantially planar, ridged, scalloped, or have any other known and/or convenient configuration. In some embodiments, the surface of a rim 104 can be angled relative to a central portion 102. As shown in FIG. 1c, a rim 104 can be raised to approximately 30-degrees above the plane of a substantially planar central portion 102, but in other embodiments can have any other known and/or convenient angle.

A plate 100 can have at least one substantially transparent region 106. In some embodiments, substantially the entirety of a plate 100 can be substantially transparent. In alternate embodiments, a central portion 102 can be a substantially transparent region 106, while a rim 104 surrounding a central portion 102 can be substantially opaque, substantially translucent and/or transparent. In other embodiments, a portion or substantially the entirety of a rim 104 can be substantially or entirely transparent. A substantially transparent region 106 of a plate 100 can be fabricated from glass, plastic, or any other known and/or convenient substantially transparent or translucent material.

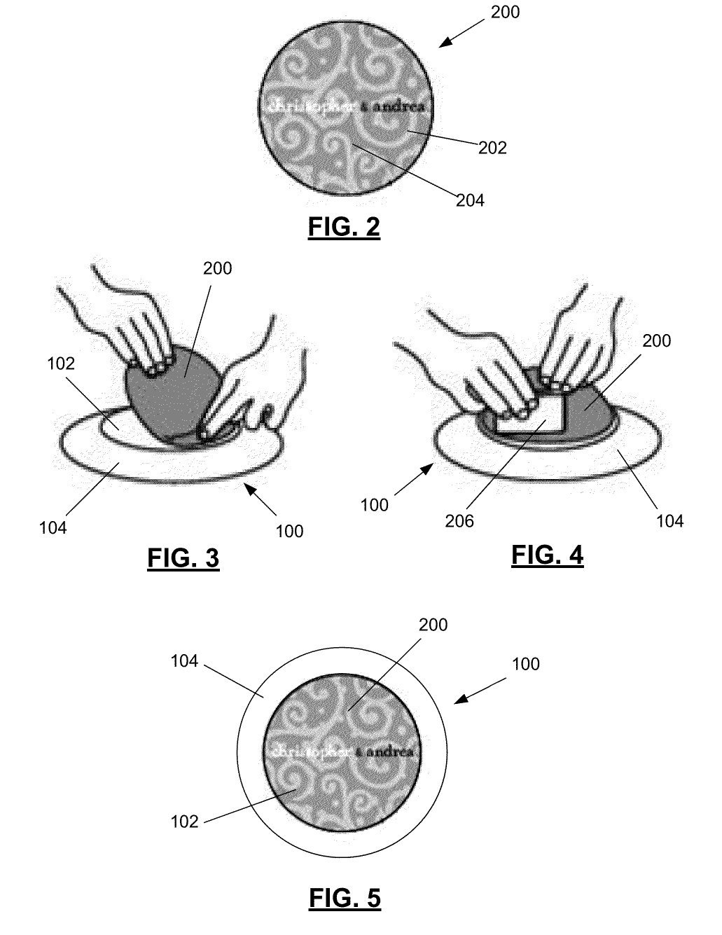

FIG. 2 depicts a decal 200. A decal 200 can have a substrate having an upper surface and a lower surface. In some embodiments, as shown in FIG. 2, a decal 200 can have substantially the same geometry as a substantially transparent region 106, but in other embodiments can have any other known and/or convenient geometry. A decal 200 can be fabricated from vinyl, film, plastic, paper, or any other known and/or convenient material. The upper surface of a decal 200 can display a design 202. A design 202 can be printed, painted, drawn, etched, or otherwise deposited by any other known and/or convenient method onto a decal 200. A design 202 can include text, pictures, patterns, shapes, colors, logos, or any other known and/or convenient design element. In some embodiments, a design 202 can be a photograph and name of a person celebrating a birthday; a holiday design displaying a Christmas scene; a pattern that can match the pattern of a tablecloth or other table linens; or any other known and/or convenient design. In some embodiments, users can purchase or acquire prefabricated decals 200 that can have preselected designs 202. In other embodiments, decals 200 can be customized by a user with a custom design 202.

The upper surface of a decal 200 can be configured to selectively and removably coupled with the underside of a plate 100 at a substantially transparent section 106. As shown in FIG. 2, a substantially transparent section 106 can be a central portion 102 of a plate 100, such that a design 202 can be seen through a central portion 102 of a plate 100. In some embodiments, a non-permanent repositionable adhesive 204 that allows a decal 200 to stick to the underside of a plate 100 can be applied to the upper side of a decal. In other embodiments, a decal 200 can be fabricated from a material that can removably attach to the underside of a plate 100 through static cling. In alternate embodiments, a decal 200 can be coupled with the underside of a plate 100 with magnets, snaps, clips, or any other known and/or convenient connection mechanism on a decal 200 and/or plate 100.

In some embodiments, as shown in FIGS. 3 and 4, a decal 200 can be selectively applied to a substantially transparent region 106 of a plate 100. In use, a user can couple the upper surface of a decal 200 directly to the underside of a plate 100 at a substantially transparent region 106 of a plate 100. As shown in the embodiment of FIG. 3, a user can apply a decal 200 to the underside of a substantially transparent region 106, which can be a central portion 102, of a plate 100 using a decal's removable adhesive substance 204. As shown in FIG. 4, a user can use an application tool 400, such as a squeegee, flat-edged card, or any other known and/or convenient implement to press out wrinkles or air bubbles between a decal 200 and a plate 100, such that substantially the entire top surface of a decal 200 is directly against the underside of a plate 100.

As shown in FIG. 5, after a decal 200 has been applied to the underside of a plate 100, a design 202 on the upper side of a decal 200 can be visible through a substantially transparent region 106 of a plate 100 when a plate 100 is viewed from above. A plate 100 can be used to display or serve food without the food touching a decal 200, because a decal 200 can be on the underside of a plate 100 rather than on the upper side of a plate 100 that comes into contact with food.

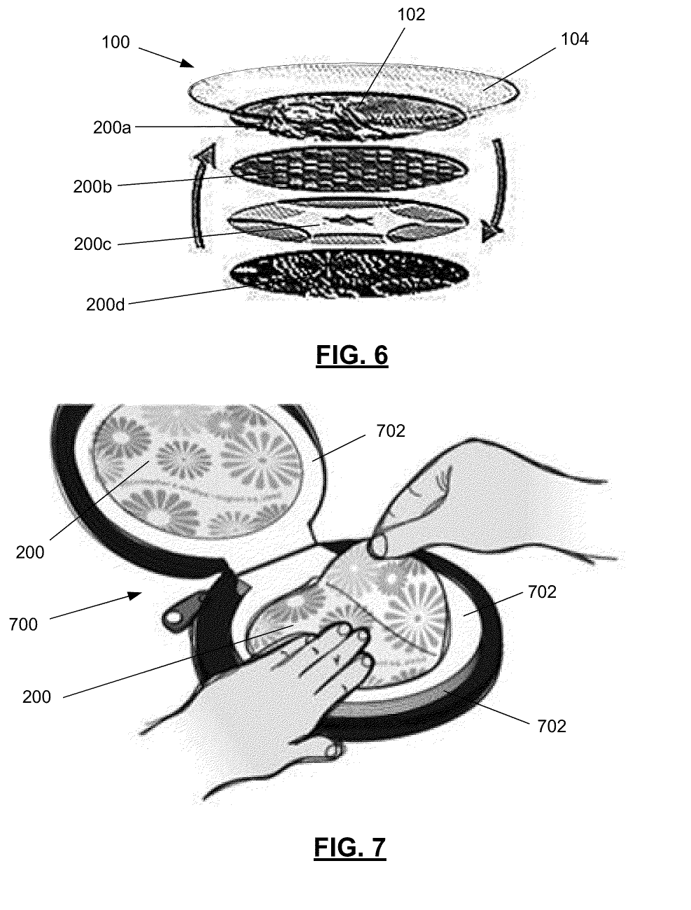

A user can choose to remove a decal 200 at any time and/or replace a decal 200 with a different decal 200 having a different design 202, such as the embodiments of decals 200a-200d shown in FIG. 6. In some embodiments, a user can have a selection of different decals 200 with designs 202 for different occasions, and can select and replace decals 200 to customize a plate 100 without needing to replace an entire plate 100, thereby saving storage space and the expense of purchasing new plates with different designs for each occasion.

A decal 200 can be removed from a plate 100 at any time. A user can remove a decal 200 from a plate 100 when a plate 100 is to be washed in a dishwasher. However, in some embodiments a user can choose to retain a decal 200 on a plate 100 when washing the upper side of a plate 100 by hand because a decal 200 is on the underside of a plate 100.

As shown in FIG. 7, decals 200 that are not presently coupled with a plate 100 can be stored in a storage device 700. In some embodiments, a storage device 700 can be a portfolio, but in other embodiments can be a wallet, a lidded container, a folder, an album, a book, an envelope, or any other known and/or convenient container. In some embodiments, a storage device 700 can have a plurality of pages 702 that can be fabricated from a similar material to that of a substantially transparent section of a plate 100. A user can selectively couple a decal 200 with a page 702 in a manner similar to that of applying a decal 200 to a plate 100, as described above. A user can couple decals 200 to pages 702 to store decals 200, such that a user has an option of removing a decal 200 from a storage device 700 to apply a decal 200 to a plate 100 at any time.

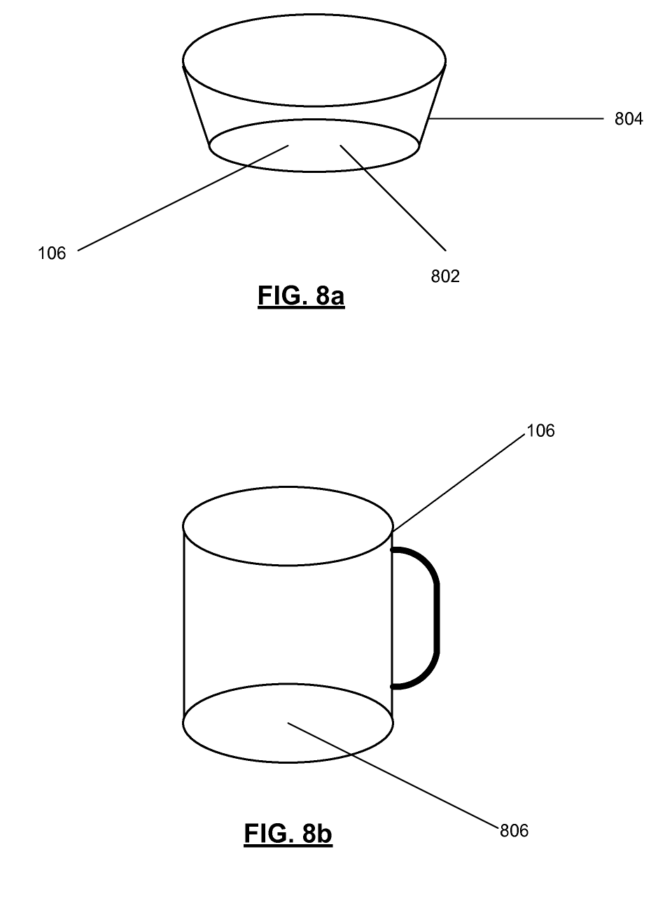

FIG. 8a depicts another embodiment of the present device where a dish can be a bowl 800. In such embodiments, a bowl 800 can have a substantially transparent section 106, which, as shown in FIG. 8a, can be a central bottom portion 802. In other embodiments a substantially transparent section 106 can be walls 804 of a bowl 800.

FIG. 8b depicts another embodiment of the present device where a dish can be a drinking vessel 806. As shown in FIG. 8b, a drinking vessel 806 can be a mug and can have a substantially transparent section 106 at its central base portion. In other embodiments, a drinking vessel 806 can be a stemmed or stemless wine glass, tumbler, cocktail glass, tall drinking glass, or any other known and/or convenient configuration. In still further alternate embodiments, a dish can be a platter and/or any other known and/or convenient devise capable of presenting and/or retaining food and/or liquid.

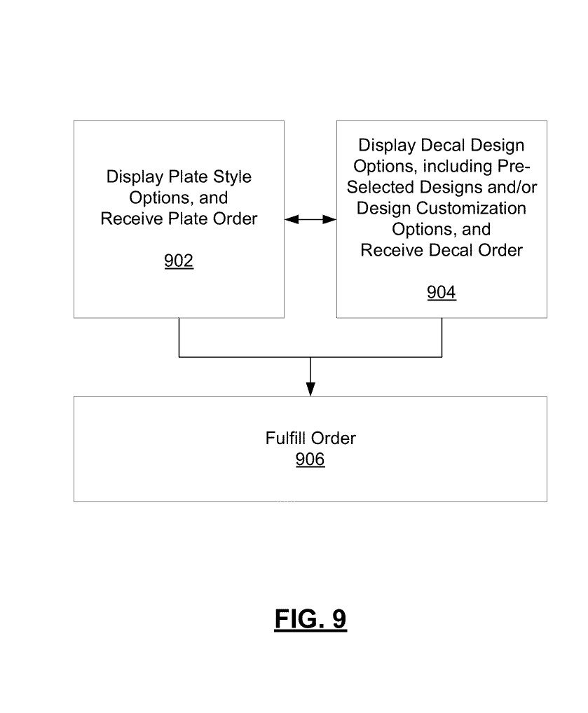

FIG. 9 depicts a method of providing plates 100 and/or pre-made or custom decals 200 to a user. At 902, a system such as a website running on a server can receive an order for one or more plates 100 and/or one of more different dishes. A system can have a selection of different plates 100 available to order, such as substantially circular plates 100 shown in FIG. 1a and substantially square plates 100 shown in FIG. 1b. Plates can also have color rims and/or be disposable.

At 904, a system can receive an order for one or more decals 200. A system can have a selection of decals 200 with different pre-made designs 202 available to order. In some embodiments, a system can also, or alternatively, display options for a user to create and order decals 200 with a user-customized design 202 and/or a user's modification of a pre-made design 202. A system can have options to upload, input or customize text, colors, photographs, shapes, patterns, or any other known and/or convenient design element(s) 202.

At 906, a user's order of plates 100 and/or decals 200 can be manufactured/produced on-demand and/or pre-manufactured/pre-made, fulfilled and provided to a user. In some embodiments, ordered decals 200 with pre-made designs 202 can be shipped from a warehouse. In other embodiments, decals 200 can be produced on demand when ordered. In some embodiments, ordered decals 200 can be printed with a user-selected or user-customized design 202 after a user's order has been placed. In some embodiments, decals 200 can be shipped to the user in a storage device 700, such as a portfolio shown in FIG. 7, and/or an application tool 206 can be included with a user's order.

Although the invention has been described in conjunction with specific embodiments thereof, it is evident that many alternatives, modifications and variations will be apparent to those skilled in the art. Accordingly, the invention as described and hereinafter claimed is intended to embrace all such alternatives, modifications and variations that fall within the spirit and broad scope of the appended claims.

What is claimed is:

1. A customizable tableware system, comprising:
a dish having a substantially transparent region; and
a decal having an upper surface displaying a design,
wherein the upper surface of said decal is configured to selectively and removably couple with an underside of said dish at said substantially transparent region such that said design is visible through said substantially transparent region from an upper side of said dish.

2. The system of claim 1, wherein said substantially transparent region is located substantially within a portion of said dish.

3. The system of claim 2, wherein said portion of said dish is a central portion of said dish.

4. The system of claim 2, wherein said portion of said dish is a perimeter portion of said dish.

5. The system of claim 2, further comprising a non-permanent repositionable adhesive substance applied to the upper surface of said decal.

6. The system of claim 5, further comprising a storage device for said decals.

7. The system of claim 6, wherein said storage device is selected from the group consisting of: a portfolio, a wallet, a lidded container, an album, an envelope, and a folder.

8. The system of claim 1, wherein said dish is selected from the group consisting of: a plate, a platter, a bowl, and a drinking vessel.

9. A method of providing a customizable tableware system, comprising the steps of:
offering a selection of different dishes;
offering a selection of decals with different pre-made designs;
offering a first option to modify said pre-made designs;
offering a second option to create a custom design;
receiving an order for at least one decal; and
fulfilling said order.

10. The method of claim 9, wherein the second option to create said custom design further comprises a third option to upload design elements.

11. The method of claim 9, wherein said system is a website running on a server.

12. The method of claim 9, wherein said orders are fulfilled by shipping from a warehouse.

13. The method of claim 9, wherein said orders are fulfilled by on-demand production.

14. The method of claim 12, wherein said orders are shipped in a storage device.

15. The method of claim 10, wherein said orders include an application tool.
